(19) United States
(12) Patent Application Publication
(10) Pub. No.: US 2026/0160911 A1
(43) Pub. Date: Jun. 11, 2026

(54) SIMULTANEOUS DISTRIBUTED FIBER-OPTIC TELEMETRY AND SEISMIC ACQUISITION

(71) Applicant: SAUDI ARABIAN OIL COMPANY, Dhahran (SA)

(72) Inventors: Anton Egorov, Moscow (RU); Marwan Charara, Moscow (RU); Pavel Golikov, Dhahran (SA); Constantinos Tsingas, Dhahran (SA)

(73) Assignees: Aramco Innovations LLC, Moscow (RU); SAUDI ARABIAN OIL COMPANY, Dhahran (SA)

(21) Appl. No.: 18/723,961

(22) PCT Filed: Sep. 8, 2023
(86) PCT No.: PCT/RU2023/000266

§ 371 Date: Jun. 25, 2024

(51) Int. Cl. G01V 1/34; E21B 44/00; E21B 47/12; G01V 1/22; G01V 1/30

(52) U.S. Cl. CPC G01V 1/345; E21B 7/04; G01V 1/226; G01V 1/305

(57) ABSTRACT

Examples of methods and systems are disclosed. The methods may include detecting, using a plurality of autonomous seismic sensors, a first set of seismic signals. The methods may also include transmitting, by the autonomous seismic sensors, a plurality of encoded acoustic signals to a distributed acoustic sensing (DAS) system; wherein each encoded acoustic signal may include a representation of a seismic wave from the first set of seismic signals. The methods may further include detecting, using the DAS system, a superposition of the encoded acoustic signals and a second set of seismic signals. The methods still may further include determining, using a seismic processing system, the first set of seismic signals and the second set of seismic signals from the superposition. The methods may also include forming, using the seismic processing system, a seismic image from first set of seismic signals and the second set of seismic signals.

### BACKGROUND

In the oil and gas industry, seismic surveys are conducted over subsurface regions of interest during the search for, and characterization of, hydrocarbon reservoirs. In seismic surveys, a seismic source generates seismic waves that propagate through the subterranean region of interest and are detected by seismic receivers. The seismic receivers detect and may store a time-series of samples of earth motion caused by the seismic waves. The collection of time-series of samples recorded at many receiver locations generated by a seismic source at many source locations constitutes a seismic data set.

To determine the earth structure, including the presence of hydrocarbons, the seismic data set may be processed. Processing a seismic data set includes a sequence of steps designed to correct for a number of issues, such as near-surface effects, noise, irregularities in the seismic survey geometry, etc. Seismic data may be also processed to generate high resolution images of subsurface regions to assist in identification of fine geological features. A properly processed seismic data set may aid in decisions as to if and where to drill for hydrocarbons.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method. The method includes detecting, using a plurality of autonomous seismic sensors, a first set of seismic signals regarding a subsurface region of interest. The method also includes transmitting, by the plurality of autonomous seismic sensors, a plurality of encoded acoustic signals to a distributed acoustic sensing (DAS) system; wherein each encoded acoustic signal includes a representation of a seismic wave drawn from the first set of seismic signals. The method further includes detecting, using the DAS system, a superposition of the plurality of encoded acoustic signals and a second set of seismic signals regarding the subsurface region. The method still further includes determining, using a seismic processing system, the first set of seismic signals and the second set of seismic signals from the superposition. The method also includes forming, using the seismic processing system, a seismic image from first set of seismic signals and the second set of seismic signals.

In general, in one aspect, embodiments disclosed herein relate to a system. The system includes a plurality of autonomous seismic sensors configured to detect a first set of seismic signals. The plurality of autonomous seismic sensors is also configured to transmit a plurality of encoded acoustic signals, wherein each encoded acoustic signal includes a representation of a seismic wave drawn from the first set of seismic signals. The system also includes a distributed acoustic sensing (DAS) system configured to detect a superposition of a second set of seismic signals and the plurality of encoded acoustic signals after transmission by the plurality of autonomous seismic sensors. The system further includes a seismic processing system configured to determine the first set of seismic signals and the second set of seismic signals from the superposition. The seismic processing system is also configured to form a seismic image from first set of seismic signals and the second set of seismic signals.

It is intended that the subject matter of any of the embodiments described herein may be combined with other embodiments described separately, except where otherwise contradictory.

Other aspects and advantages of the claimed subject matter will be apparent from the following description and the appended claims.

### BRIEF DESCRIPTION OF DRAWINGS

FIG. 1 shows a seismic acquisition system of a subsurface region of interest; according to one or more embodiments of the present disclosure.

FIG. 2 shows a drilling system in according to one or more embodiments.

FIG. 3 shows examples of seismic data produced by a seismic acquisition system according to one or more embodiments.

FIG. 4 shows a neural network according to one or more embodiments.

FIG. 5 shows a flowchart according to one or more embodiments.

FIG. 6 depicts a schematic diagram of a computer system according to one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

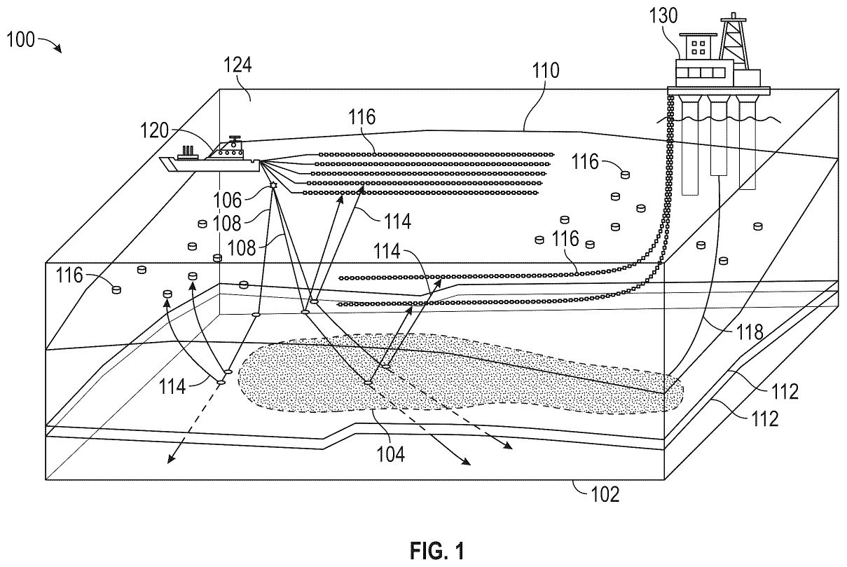

In the following description of FIGS. 1-5, any component described regarding a figure, in various embodiments disclosed herein, may be equivalent to one or more like-named components described with regard to any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a seismic signal” includes reference to one or more of such seismic signals.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

In general, disclosed embodiments include systems and methods for simultaneous acquisition of seismic waves with autonomous seismic sensors and distributed acoustic sensors. In particular, some embodiments include the use of seismic sensors deployed offshore. Measurements with offshore seismic acquisition systems may be recorded by ocean bottom nodes or ocean bottom cables and transmitted in real-time via wired connections to a seismic processing system at the surface. Alternatively, recorded measurements may be stored in an internal memory of the seismic sensor and downloaded upon retrieval of the sensor at the surface. The measurements can directly be used by the seismic processing system to generate seismic images for subsurface characterization.

However, data transmission is a common problem when measurements are conducted with seismic sensors located on the seabed or in a body of water. Wired sensors require electrical power, cables, and conduit to reach processing devices often in remote locations. Deploying wired sensors offshore may be costly, inconvenient, and often impossible. Furthermore, installation processes may be prone to errors and operations may be risky in extreme offshore conditions. Accordingly, methods and processing techniques to improve offshore seismic acquisition campaigns may be implemented.

The resulting seismic images may then be used for seismic data interpretation, such as defining the spatial location and extent of a hydrocarbon reservoir. Thus, the disclosed methods are integrated into the established practical applications for creating and/or improving seismic images that are in turn used in the search for, and extraction of hydrocarbons from, subsurface hydrocarbon reservoirs. The disclosed methods represent an improvement over existing methods for at least the reasons of lower cost and increased efficacy.

FIG. 1 shows a seismic acquisition system (100) of a subsurface region of interest (102), according to one or more embodiments. In some case the subsurface region of interest (102) may lie beneath a lake, sea, or ocean. The subsurface region of interest (102) may contain a hydrocarbon reservoir (A well site (130) may be located in the subsurface region of interest (102) for accessing the hydrocarbon reservoir (104) via a wellbore (118). The seismic acquisition system (100) may utilize a seismic source (106) that generates radiated seismic waves (108). The type of seismic source (106) may depend on the environment in which it is used. For example, in water the seismic source (106) may be an airgun. The radiated seismic waves (108) may return to the surface as refracted seismic waves or reflected seismic waves (114).

Refracted seismic waves and reflected seismic waves (114) may occur, for example, due to geological discontinuities (112) that may be also known as “seismic reflectors”. The geological discontinuities (112) may be, for example, planes or surfaces that mark changes in physical or chemical characteristics in a geological structure. The geological discontinuities (112) may also be boundaries between faults, fractures, or groups of fractures within a rock. The geological discontinuities (112) may delineate a hydrocarbon reservoir (104).

Refracted seismic waves and reflected seismic waves (114) may be detected by seismic receivers (116) deployed at the surface (124), on the seafloor (110), or at other depths in the body of water, Radiated seismic waves (108) that propagate from the seismic source (106) directly to the seismic receivers (116), known as direct seismic waves, are also detected by the seismic receivers (116). Similarly, in marine locations the radiated seismic waves (108) may return to the body of water (e.g., lake, ocean, etc.), after being reflected by geological discontinuities (112), as reflected seismic waves (114). Airguns may be used as seismic sources (106) being towed, or pulled, by a vessel (120) while conducting a seismic survey.

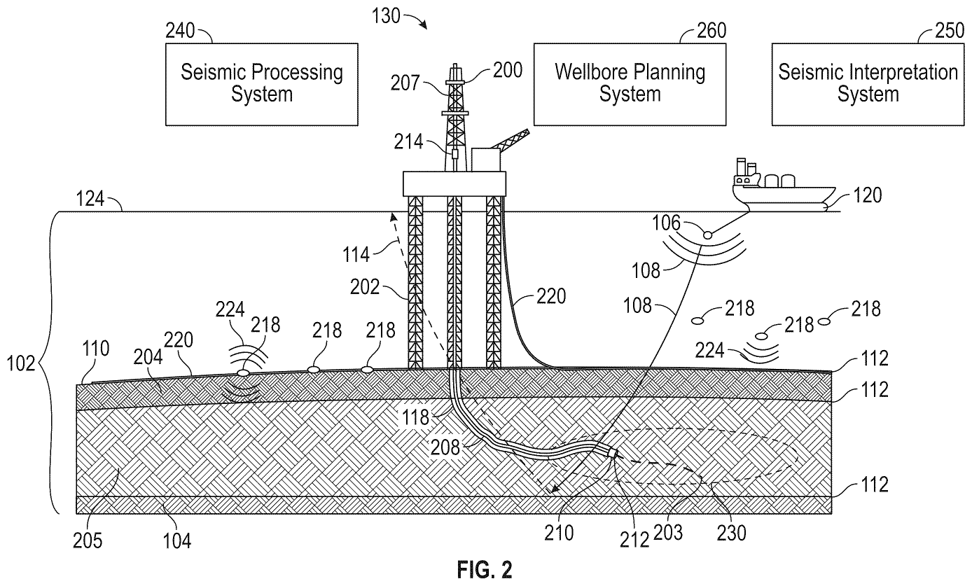

FIG. 2 shows a well site (130) in accordance with one or more embodiments. In general, well sites (130) may be configured in a myriad of ways. Therefore, the well site (130) in FIG. 2 is not intended to be limiting with respect to the particular configuration of the drilling equipment. The well site (130) is depicted as being offshore, and drilling may be carried out with or without use of a marine risers (202).

The well site (130) may include a drilling system (200) configured to drill a wellbore (118), along a wellbore trajectory (203), into the subsurface region (102) including various formations (204, 205) to reach a hydrocarbon reservoir (104) within the subsurface region (102), and specifically to a drilling target (230). The wellbore trajectory (203) may be a curved or a straight trajectory. All or part of the wellbore trajectory (203) may be vertical, and some wellbore trajectory (203) may be deviated or have horizontal sections.

For the purpose of drilling a new section of the wellbore (118), the drilling rig (207) may include a drillstring (208) attached to the drilling rig (207) located on the surface (124). The drillstring (208) may include one or more drill pipes connected to form conduit and a bottom hole assembly (“BHA”) (210) disposed at the distal end of the conduit. The BHA (210) may include a drill bit (212) to cut into the subsurface rock. The BHA (210) may include measurement tools, such as a measurement-while-drilling (MWD) tool and logging-while-drilling (LWD) tool. Measurement tools may include sensors and hardware to measure downhole drilling parameters, and these measurements may be transmitted to the surface (124) using any suitable telemetry system known in the art. The BHA (210) and the drillstring (208) may include other drilling tools known in the art but not specifically shown.

During a drilling operation the drillstring (208) is rotated relative to the wellbore (118), and weight is applied to the drill bit (212) to enable the drill bit (212) to break rock as the drillstring (208) is rotated. In some cases, a top drive (214) may be coupled to the top of the drillstring (208) and is operable to rotate the drillstring (208). In further embodiments, the drill bit (212) may be rotated using a combination of a drilling motor and the top drive (214).

While cutting rock with the drill bit (212), drilling fluid (commonly called “mud”) may flow into the drillstring (208) through appropriate flow paths in the top drive (214). The mud flows down the drillstring (208) and exits into the bottom of the wellbore (118) through nozzles in the drill bit (212). The mud in the wellbore (118) then flows back up to the surface in an annular space between the drillstring (208) and the wellbore (118) with entrained cuttings. Typically, the cuttings are removed from the mud, and the mud is reconditioned as necessary, before pumping the mud again into the drillstring (208).

The drilling system (200) may be disposed at and communicate with other systems in the well environment, such as a seismic acquisition system (100), a seismic processing system (240), a seismic interpretation system (250), and a wellbore planning system (260).

A seismic interpretation system (250) is primarily used by geoscientists, seismic interpreters, and exploration teams in the oil and gas industry for analyzing seismic data to understand subsurface geological structures. Seismic interpreters use the workstation to visualize seismic data, including 2D and 3D seismic volumes, cross-sections, time slices, and attribute maps. These visualizations provide insights into subsurface structures, faults, and potential hydrocarbon reservoirs.

Interpreters may pick and interpret key geological horizons within seismic data to identify stratigraphic layers, boundaries, and structural features. Horizon interpretation tools and workflows allow for the accurate extraction of geological information from seismic volumes. Seismic interpretation systems enable interpreters to identify and interpret subsurface faults that may impact hydrocarbon reservoirs. Fault interpretation tools and visualization techniques help in understanding fault geometry, connectivity, and spatial relationships. Seismic attributes, such as amplitude, frequency, and gradient, provide additional information about subsurface properties and can be analyzed using various algorithms and statistical methods. Attribute analysis tools in the workstation aid in defining reservoir characteristics, identifying anomalies, and highlighting potential hydrocarbon traps.

Interpreters may use the seismic interpretation systems to build 3D geological models by integrating seismic data with well-log data, geological knowledge, and other geophysical information. These models help in estimating reservoir properties, optimizing well locations, and predicting hydrocarbon distribution. Interpreters may analyze and characterize hydrocarbon reservoirs by integrating different data sources, including seismic data, well logs, production data, and seismic inversion results. Workstations provide tools for reservoir property estimation, quantitative analysis, and reservoir performance evaluation.

Seismic interpretation systems facilitate prospect generation and evaluation, where interpreters identify and assess areas with high hydrocarbon exploration potential. They can perform detailed geological and geophysical analysis, identify drilling targets, and quantify the risk and uncertainty associated with potential prospects. Finally, workstations enable interpreters to collaborate with team members, share interpretation results, and communicate findings effectively: Interpretation software allows for the creation of reports, annotated images, and presentations to communicate geological interpretations to stakeholders.

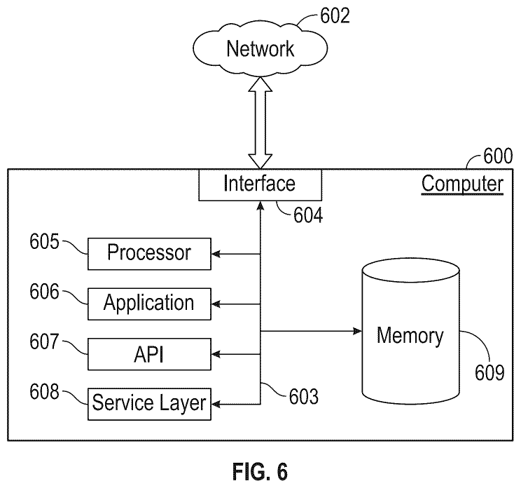

Seismic interpretation systems are essential tools for geoscientists involved in exploration and production activities, helping them make informed decisions about drilling locations, optimize production strategies, and understand complex subsurface geological structures. A seismic interpretation system is a specialized computer system used by geoscientists and seismic interpreters for analyzing and interpreting seismic data. The seismic interpretation system may be implemented on a computing device such as that shown in FIG. 6.

Seismic interpretation involves intensive tasks like data visualization, horizon picking, attribute analysis, and 3D modeling. A high-performance seismic interpretation workstation with a powerful processor, ample memory, and a high-resolution display is essential to handle these computationally demanding tasks efficiently. Dedicated GPUs may be crucial for real-time rendering of seismic data, enabling smooth and interactive visualization. GPUs with high memory and parallel processing capabilities accelerate tasks like volume rendering and horizon visualization.

Seismic interpretation often involves working with large and complex datasets. Multiple high-resolution monitors allow interpreters to view seismic data, cross-sections, time slices, attribute maps, and other visualizations simultaneously, enhancing productivity and analysis accuracy. A seismic interpretation system may be equipped with industry standard applications tailored for seismic interpretation, such as seismic data processing and visualization tools, horizon and fault interpretation systems, attribute analysis software, and 3D modeling software.

Seismic interpretation projects generate substantial amounts of data, including seismic volumes, processed data, interpretation results, and velocity models. A high-capacity and fast storage system, such as solid-state drives (SSDs) or RAID arrays, is necessary to store and access his data efficiently Seismic interpretation systems often require network connectivity to access centralized data repositories, collaborate with colleagues, and share interpretation results. A robust network infrastructure with fast Ethernet or fiber connections ensures smooth data transfer and collaboration capabilities.

Essential peripherals like keyboards, mice, and graphics tablets enable efficient interaction with data and software interfaces. Additionally, color-calibrated and high-accuracy input devices enhance the precision of interpretation tasks like picking horizons or drawing geological features. Seismic interpretation systems should have backup solutions in place to protect valuable data from loss or damage. Automated backup systems, external storage devices, or network-attached storage (NAS) can be utilized to ensure data safety. In some cases, seismic interpreters may need remote access to their seismic interpretation system or collaborate with colleagues remotely. Setting up remote access capabilities, such as Virtual Private Networks (VPNs) or remote desktop solutions, allows interpreters to work from different locations and share their work effectively, Seismic interpretation workstations are customized to meet the needs of interpreters and the specific requirements of projects. The hardware specifications may vary based on factors like the complexity of interpretations, the size of datasets, and the software tools utilized.

The drilling system (200) may control at least a portion of a drilling operation by providing controls to various components of the drilling operation. In one or more embodiments, the drilling system (200) may receive well-measured data from one or more sensors and/or logging tools arranged to measure controllable parameters of the drilling operation. During operation of the drilling system (200), the well-measured data may include mud properties, flow rates, drill volume and penetration rates, rock physical properties, etc.

In some embodiments, the seismic acquisition system (100) may include autonomous seismic sensors (218) and fiber-optic cables (220). In offshore locations, the autonomous seismic sensors (218) may be deployed on the seafloor (110). In some implementations, the autonomous seismic sensors (218) are distributed in a horizontal direction at the same depth. In other implementations, the autonomous seismic sensors (218) are distributed at different depths. On the other hand, the fiber-optic cables (220) may be installed along the drilling rig (207) or on the seafloor (110). In some embodiments the fiber-optic cables (220) may extend from the drilling rig (207) to the seafloor (110). On the drilling rig (207) one end of the fiber-optic cables (220) may be connected to a laser source and to an interrogator configured to form a distributed acoustic sensing (DAS) system.

The autonomous seismic sense (218) may be completely wireless and designed for autonomous measurements, each with internal memory and powered by a battery: The autonomous seismic sensors (218) may sink due to gravity, conduct measurements, and record the measurements in the internal memory. In one or more embodiments, the autonomous seismic sensors (218) may have means for independent movement (e.g., propellers, detachable weights) The autonomous seismic sensors (218) may travel back to the surface (124) to facilitate the retrieval of their recordings, but this procedure entails a delay between the time when the measurements are recorded and the time when they are available for analysis. In addition, the size of recordings retrieved at the surface (124) may be limited by the internal memory of the autonomous seismic sensors (218), In other embodiments, the autonomous seismic sensors (218) may be attached to the fiber-optic cables (220).

The autonomous seismic sensors (218) may contain a sensing block, which contains various sensors and a battery. The sensors in the sensing block may include, but are not limited to, sensors of pressure, temperature, magnetic, electrical, acoustic, and/or seismic fields. For example, the seismic field sensor may include one or more hydrophones, geophones, and/or accelerometers. The autonomous seismic sensors (218) also contain a data transmission block, that may comprise an encoding module that transforms and encodes the measurements from the sensing block. In addition, each autonomous seismic sensor (218) may have a unique identification number and an internal clock. The data transmission block may include the functionality to add the unique identification number and a timestamp from its internal clock to any data transmission. The addition may include encoding the unique identification number and a timestamp into a digital format. The data transmission block may also include an acoustic transmitter, which transmits the signals in the encoded/modulated form as acoustic waves (224) from the autonomous seismic sensor through the surrounding water to a fiber-optic cable (220). Any signal modulation technique of choice may be used by the encoding module, including, but not limited to various types of frequency shift keying, phase shift keying, or amplitude shift keying without limiting the scope of the invention.

Fiber-optic cables (220) are widely used for sensor data transmission in various domains. Sensors may be directly connected to the fiber-optic cable (220) and generate optical signals that transmit sensor measurements through the fiber. When used in this way, the measurements obtained by the sensors are modulated onto a carrier wave of light and transmitted through the fiber-optic cable (220) to a receiver that decodes the signals.

In other embodiments, the fiber-optic cable (220) itself may act as a sensor or a plurality of sensors distributed along its length. When used in this way a coherent laser pulse is sent along an optic fiber, and scattering sites within the fiber cause the fiber to act as a distributed interferometer with a gauge length approximately equal to the pulse length. The intensity of the reflected light is measured as a function of time after transmission of the laser pulse. When the pulse has had time to travel the full length of the fiber and back, the next laser pulse can be sent along the fiber. Changes in the reflected intensity of successive pulses from the same region of fiber are caused by changes in the optical path length of that section of fiber. This type of system is very sensitive to variations, including strains generated by seismic waves, of the fiber and measurements can be made almost simultaneously at all sections of the fiber.

In one or more embodiments, a fiber-optic cable (220) is used to detect acoustic waves as a way to transmit information from autonomous seismic sensors (218) located downhole or on the seafloor (110) to the surface (124) without the need for a direct connection from the surface (124) to the autonomous seismic sensors (218). In this case, the autonomous seismic sensors (218) may encode the detected seismic waves using a signal modulation technique and transmit it as an acoustic wave (224) via an acoustic transmitter installed in the autonomous seismic sensors (218). The fiber-optic cable (220) may detect these acoustic signals in the same way as the seismic waves may be detected.

The DAS system comprises the fiber-optic cables (220) along with the interrogator; it records the acoustic s (224) using the installed the fiber-optic cables (220) and transmits it to the surface (124), or to the drilling rig (207) where it can be demodulated by the interrogator to retrieve the recordings of the autonomous seismic sensors (218). Any sensor or measurement device instrumented with an acoustic transmitter may act as a measurement tool and transmit data to the interrogator through the fiber-optic cable (220). The interrogator measures changes in the phase, wavelength, and intensity of backscattered light signals. Changes in wavelength may be used to measure changes in temperature in the fiber-optic cable (220). Changes in intensity may be used to detect changes in pressure. Changes in the phase of backscattered light signals may be indicative of strain in the fiber-optic cable (220). Continuously measuring the change in strain throughout the fiber-optic cable (220) may allow it to be used as a detector of acoustic signals impinging upon it.

A fiber-optic cable (220) may be of any conventional type, which always has intrinsic backscattering, or the fiber-optic cable (220) may be engineered in a specific way, for example, with Bragg gratings (capable of selectively reflecting and transmitting certain wavelengths of light) The fiber optic cable (220) can be straight or shaped in various manners, e.g., helical. Deploying the fiber-optic cable (220) on the seafloor (110), or trenched into the seafloor, may allow it to be used for continuous measurement of acoustic signals. The fiber-optic cables (220) that have been deployed in the drilling rig (207) or on the seafloor (110) for other purposes (e.g., for traditional data transmission) may be used as part of the DAS system described in the proposed method. Making use of already installed fiber-optic cables (220) may allow the conduction of cost-effective seismic data acquisition.

A seismic processing chain consists of several key groups of functions, each serving a specific purpose in the processing workflow. For example, the steps may include data injection, the loading, sorting and arrangement of raw seismic data, acquired from various sources such as seismographs or land-based sensors, into the processing system. This data may include seismic waveforms, and may also include well logs, and survey information.

Data quality control is critical in seismic processing. A seismic processing system employs various tools and techniques to identify and correct any artifacts, noise, or errors in the data. This step ensures the accuracy and reliability of subsequent processing steps.

Further, the raw seismic data may be “conditioned”, i.e., the raw seismic data is pre-processed to enhance its quality and make it suitable for further analysis. This step may include procedures such as filtering, deconvolution, noise suppression, and signal enhancement.

In addition, data may be “stacked” Stacking involves combining multiple seismic traces to improve data quality and increase signal to noise ratio. This may enhance the identification of subsurface features and reduces random noise interference.

Velocity analysis is crucial for accurate imaging and interpretation of subsurface structures. It involves estimating the time depth relationship of seismic reflections and determining the velocity model of the subsurface. A typical seismic processing system will provide methods for multiple methods of performing velocity analysis, including normal moveout analysis; iterative Kirchhoff time- and depth-migration, tomography, and full waveform inversion.

Migration is a key step that transforms the processed seismic data from the time domain to the depth domain, providing a more accurate representation of subsurface structures. It helps in locating and positioning geological features accurately.

The seismic processing system may provide visualization tools to render the seismic data in a visual format, enabling geoscientists to analyze, interpret, and perform visual quality control more effectively: This can include 2D/3D seismic displays, depth slices, horizon maps, and virtual reality visualization.

The final step involves generating reports and documenting the results of the seismic processing workflow. This includes recording the processing parameters, interpretation results, and any uncertainties or limitations associated with the data processing.

To perform these groups of steps for even a small commercial seismic dataset, a seismic processing system is required. A seismic processing system typically consists of various hardware components that work together to process and analyze seismic data, Here are some essential hardware components commonly found in a seismic processing system:

Seismic processing requires significant computational power and storage capacity. High-performance servers and workstations are used to handle the massive amount of data and perform complex processing algorithms efficiently. Seismic data can be massive, reaching terabytes or even petabytes in size. Reliable and high-capacity storage systems, such as Network Attached Storage (NAS) or Storage Area Networks (SAN), are utilized to store and manage the seismic data effectively. In some cases, where processing demands are extremely high, a seismic processing system may utilize cluster systems. Clusters are groups of interconnected computers or servers that work together to distribute the processing workload, enabling parallel processing and faster data analysis. A robust and high-speed network infrastructure is vital for seamless data transfer between different components of the seismic processing system. This ensures efficient communication and data sharing, especially in multi-node or distributed processing environments.

Some seismic processing systems may use GPUs for accelerating the computation of seismic processing algorithms. Their parallel processing capabilities significantly speed up tasks such as migration, inversion, and visualization. Despite advances in storage technology, data on tapes is still often used for long-term archiving and backup purposes. Tape systems provide high-capacity, cost-effective, and reliable storage solutions for seismic data. Various peripherals such as monitors, keyboards, mice, network switches, uninterruptible power supply (UPS), and backup power generators complete the hardware setup of a seismic processing system. These peripherals ensure smooth operation, user interaction, and data integrity.

The software/firmware are at least as integral a part of the seismic processing system as the hardware components and a seismic processing system equipped with a unique software program is at least as distinctively different from other seismic processing systems without the unique software program as a seismic processing system with GPUs is different from one without GPUs.

The seismic processing system (240) may be configured to perform processing steps devoted to the separation of the modulated signals generated by the autonomous seismic sensors (218) and the fiber-optic cables (220) from each other as well as from the background acoustic noise recorded by the DAS system. These steps can be carried out by a machine-learning system trained in advance using data collected in the field or simulated data. The machine learning system can be based on neural networks of different types, but not limited to the following: multilayer perceptron, convolutional neural networks, recurrent neural networks, transformer networks. After the optional separation procedure, the seismic processing system (240) may conduct demodulation of the identified signals to obtain the recordings from each of the autonomous seismic sensors (218).

In one or more embodiments, the machine learning system may be trained using synthetic or semi-synthetic datasets. Two separate datasets are created-one of the datasets consists of samples of measured acoustic noise, and another dataset consists of clean samples of encoded sensor signals (which can be measured or synthetically generated). The training dataset may then be created by weighted summation of acoustic noise samples with the clean encoded sensor signals, and the clean sensor signals without acoustic noise act as targets/labels. In this case, the task of the machine-learning system is to remove the noise and is similar to machine learning-based noise removal methods for images.

The separation of different autonomous seismic sensor (218) signals from the fiber-optic cables (220) signals also be performed by machine learning algorithms. For example, the training dataset may consist of the signals transmitted to the surface by the fiber-optic cables (220), and the recorded signals retrieved directly from the autonomous seismic sensor (218) as targets/labels.

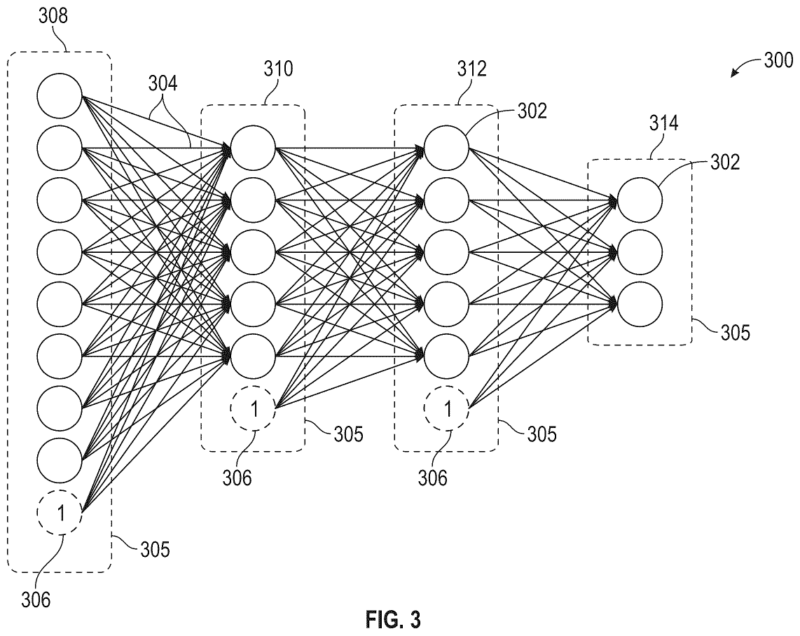

FIG. 3 shows a neural network, a common machine learning architecture for prediction/inference, which may be used to separate the signals recorded by multiple autonomous seismic sensors (218) and by the fiber-optic cables (220) and from background noise. At a high level, a neural network (300) may be graphically depicted as comprising nodes (302), where here any circle represents a node, and edges (304), shown here as directed lines. The nodes (302) may be grouped to form layers (305). FIG. 3 displays four layers (308, 310, 312, 314) of nodes (302) where the nodes (302) are grouped into columns, however, the grouping need not be as shown in FIG. 3. The edges (304) connect the nodes (302). Edges (304) may connect, or not connect, to any node(s) (302) regardless of which layer (305) the node(s) (302) is in. That is, the nodes (302) may be sparsely and residually connected. A neural network (300) will have at least two layers (305), where the first layer (308) is considered the “input layer” and the last layer (314) is the “output layer”. Any intermediate layer (310, 312) is usually described as a “hidden layer”. A neural network (300) may have zero or more hidden layers (310, 312) and a neural network (300) with at least one hidden layer (310, 312) may be described as a “deep” neural network or as a “deep learning method” In general, a neural network (300) may have more than one node (302) in the output layer (314). In this case the neural network (300) may be referred to as a “multi-target” or “multi-output” network.

Nodes (302) and edges (304) carry additional associations. Namely, every edge is associated with a numerical value. The edge numerical values, or even the edges (304) themselves, are often referred to as “weights” or “parameters”. While training a neural network (300), numerical values are assigned to each edge (304). Additionally, every node (302) is associated with a numerical variable and an activation function. Activation functions are not limited to any functional class, but traditionally follow the form:

$$A = f ( {\sum }_{i ∈ ( incoming )} [ {( node value )}_{i} {( edge value )}_{i} ] ) \qquad Eq . ( 1 )$$

where i is an index that spans the set of “incoming” nodes (302) and edges (304) and f is a user-defined function. Incoming nodes (302) are those that, when viewed as a graph (as in FIG. 3), have directed arrows that point to the node (302) where the numerical value is being computed. Some functions for ƒ may include the linear function ƒ(x)=x, sigmoid function ƒ(x)=1/(1+e^{-x}), and rectified linear unit function ƒ(x)=max (0,x), however, many additional functions are commonly employed. Every node (302) in a neural network (300) may have a different associated activation function. Often, as a shorthand, activation functions are described by the function ƒ by which it is composed. That is, an activation function composed of a linear function ƒ may simply be referred to as a linear activation function without undue ambiguity.

When the neural network (300) receives an input, the input is propagated through the network according to the activation functions and incoming node (302) values and edge (304) values to compute a value for each node (302). That is, the numerical value for each node (302) may change for each received input. Occasionally, nodes (302) are assigned fixed numerical values, such as the value of 1, that are not affected by the input or altered according to edge (304) values and activation functions. Fixed nodes (302) are often referred to as “biases” or “bias nodes” (306), displayed in FIG. 3 with a dashed circl.

In some implementations, the neural network (300) may contain specialized layers (305), such as a normalization layer, or additional connection procedures, like concatenation. One skilled in the art will appreciate that these alterations do not exceed the scope of this disclosure.

As noted, the training procedure for the neural network (300) comprises assigning values to the edges (304). To begin training, the edges (304) are assigned initial values. These values may be assigned randomly, assigned according to a prescribed distribution, assigned manually, or by some other assignment mechanism Once edge (304) values have been initialized, the neural network (300) may act as a function, such that it may receive inputs and produce an output. As such, at least one input is propagated through the neural network (300) to produce an output. Recall, that a given data set will be composed of inputs and associated target(s), where the target(s) represent the “ground truth”, or the otherwise desired output. The neural network (300) output is compared to the associated input data target(s). The comparison of the neural network (300) output to the target(s) is typically performed by a so-called “loss function”, although other names for this comparison function such as “error function” and “cost function” are commonly employed. Many types of loss functions are available, such as the mean-squared-error function, however, the general characteristic of a loss function is that the loss function provides a numerical evaluation of the similarity between the neural network (300) output and the associated target(s). The loss function may also be constructed to impose additional constraints on the values assumed by the edges (304), for example, by adding a penalty term, which may be physics-based, or a regularization term. Generally, the goal of a training procedure is to alter the edge (304) values to promote similarity between the neural network (300) output and associated target(s) over the data set. Thus, the loss function is used to guide changes made to the edge (304) values, typically through a process called “backpropagation”.

After separating the different autonomous seismic sensor (218) signals from the fiber-optic cables (220), seismic data may be further processed for interpretation. In some embodiments, seismic data may be generated by a seismic source (106) positioned at a location denoted (xₛ, yₛ), where x and y represent orthogonal axes on the earth's surface above the subsurface region of interest (102). The seismic receivers (116) may be positioned at a plurality of seismic receiver locations denoted (xᵣ, yᵣ), with the distance between each receiver and the source being termed “the source-receiver offset”, or simply “the offset”. Thus, the direct seismic waves, refracted seismic waves, and reflected seismic waves (114) generated by a single activation of the seismic source (106) may be represented in the axes (xₛ, yₛ, xᵣ, yᵣ, t). The t-axis indicates the recording time between the activation of the seismic acquisition system (100) and the sample time at which the seismic wave is detected by the seismic receivers (116).

Seismic processing may reduce five-dimensional seismic data produced by a seismic acquisition system (100) to three-dimensional (x,y,t) seismic data by, for example, correcting the recorded time for the time of travel from the seismic source (106) to the seismic receiver (116) and summing (“stacking”) samples over two horizontal space dimensions. Stacking of samples over a predetermined time interval may be performed as desired, for example, to reduce noise and improve the quality of the signals.

Seismic data may also refer to data acquired at different time intervals, such as, for example, in cases where seismic surveys are repeated after a period of weeks, months, or years, to obtain time-lapse data. Seismic data may also be pre-processed or partially-processed data, e.g. arranged as “common shot gathers” (CSG), i.e., sorting waveforms as acquired by different receivers and having a single source location. The type of seismic data is not intended as limiting, and any other suitable seismic data is intended to fall within the scope of the present disclosure.

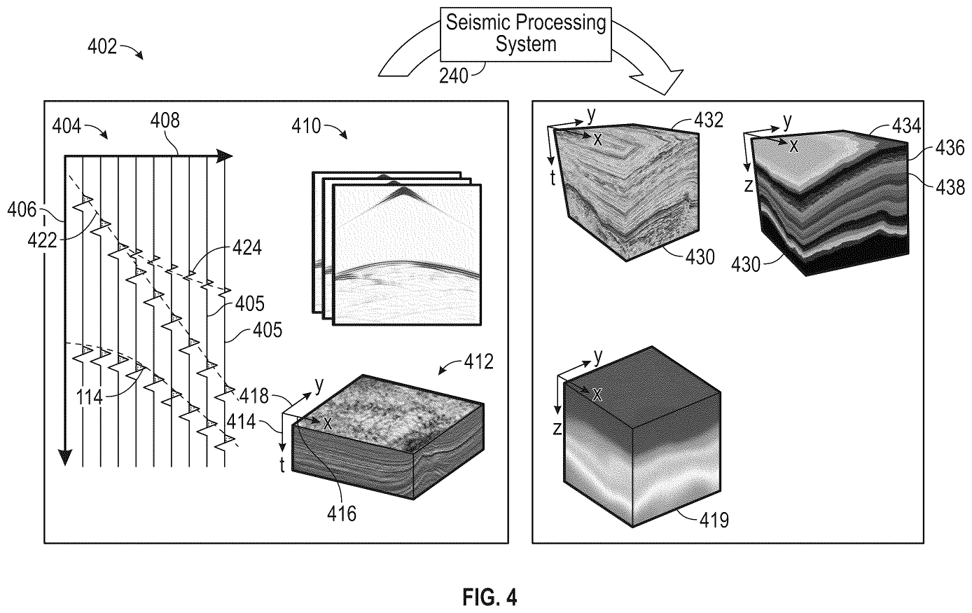

FIG. 4 shows examples of seismic data (402) produced by a seismic acquisition system (100) in accordance with one or more embodiments. An example of a CSG (404) depicts direct seismic waves (422), refracted seismic waves (424), and reflected seismic waves (114) generated by a single activation of the seismic source (106) and recorded by a plurality of seismic receivers (116) deployed, for example in a line, on the seafloor (110). Each seismic receiver (116) may record a time-series representing the amplitude of ground-motion at a sequence of discrete times. This time-series may be denoted or otherwise referred to as a “waveform”. Seismic data therefore may include a plurality of time-space waveforms (405) associated to the plurality of seismic receivers (116).

In the CSG (404) shown in FIG. 4 the vertical axis represents the time scale (406) and the horizontal axis represents the offset (408). In some embodiments, direct seismic waves (422), refracted seismic waves (424), and reflected seismic waves (114) may be identified in the CSG (404) by their arrival times, i.e., the times at which they are first detected by the seismic receivers (116). The location of a particular type of wave in seismic data (402) acquired in time and space, such as in CSG (404), may be termed as an “arrival” or as an “event”.

The CSG (404) illustrates how the arrivals are detected at later times by the seismic receivers (116) that are farther from the seismic source (106). In some embodiments, arrivals of direct seismic waves (422) in the CSG (404) may be characterized by a straight line, while arrivals of reflected seismic waves (114) may present a hyperbolic shape, as seen in FIG. 4. Refracted seismic waves (424) may be characterized by arrivals approximating a straight line in offset-time.

In one or more embodiments, seismic data (402) acquired by a seismic acquisition system (100) may be arranged in a plurality of CSGs (410) to create a 3D seismic dataset. Alternatively, the seismic data may be represented as a “seismic volume” (412) consisting of a plurality of time-space waveforms with a time axis (414), a first spatial dimension (416), and a second spatial dimension (418), where the first spatial dimension (416) and second spatial dimension (418) are orthogonal and span the Earth's surface above the subsurface region of interest (102).

Seismic data (402) may be processed by the seismic processing system (240) to generate a seismic velocity model (419) of the subterranean region of interest (102). A seismic velocity model (419) is a representation of seismic velocity at a plurality of locations within a subterranean region of interest (102). Seismic velocity is the speed at which a seismic wave, that may be a pressure-wave or a shear-wave, travel through a medium. Pressures waves are often referred to as “primary-waves” or “P-waves” Shear waves are often referred to a “secondary-waves” or “S-waves”. Seismic velocities in a seismic velocity model (419) may vary in vertical depth, in one or more horizontal directions, or both. Layers of rock are created from different materials or created under varying conditions. Each layer of rock may have different physical properties from neighboring layers and these different physical properties may include seismic velocity.

FIG. 4 schematically illustrates that in some embodiments seismic data (402) may be processed by the seismic processing system (240) to generate a seismic image (430) of the subterranean region of interest (102). For example, a time-domain seismic image (432) may be generated using a process called seismic migration (also referred to as simply “migration” herein) using a seismic velocity model (419), In seismic migration, seismic events (e.g., reflections, refractions) recorded at the surface are relocated in either time or space to the location the event occurred in the subsurface. In some embodiments, migration may transform pre-processed shot gathers from a time-domain to a depth-domain seismic image (434). In a depth-domain seismic image (434), seismic events in a migrated shot gather may represent geological boundaries (436, 438) in the subsurface. Various types of migration algorithms may be used in seismic imaging. For example, one type of migration algorithm corresponds to reverse time migration.

A seismic image (430) of high resolution may be obtained if densely-recorded data is acquired by using closely-spaced shots and seismic receivers. For example, seismic waves with a bandwidth extending up to 100 Hz or more may resolve thin features. However, acquiring densely-recorded data may be costly and in some cases not possible due to the presence of obstacles in the subsurface region of interest (102). As a result, the resolution of the seismic image (430) may not high enough to identify and determine key geological attributes in the subsurface regions of interest (102).

As illustrated in FIG. 4, processing of seismic data (402) may generate a seismic image (430) that may reveal the two or three-dimensional geometry of a subsurface region of interest (102). In particular, the geological boundaries (436, 438) may delineate a hydrocarbon reservoir (104), Identifying geological boundaries (436, 438) and other geological objects, such as faults, may be performed using the seismic interpretation system (250). If a seismic image (430) indicates the potential presence of hydrocarbons in the subsurface region of interest (102), a wellbore (118) may be planned with a wellbore planning system (260). Further, a drilling system (200) may drill a wellbore (118) to confirm the presence of those hydrocarbons.

In some embodiments, the seismic interpretation system (250) may determine a location of a hydrocarbon reservoir (104) (or other subterranean features), including the drilling target (230). Knowledge of the existence and location of the hydrocarbon reservoir (104) and other subterranean features may be transferred from the seismic interpretation system (250) to the wellbore planning system (260). The wellbore planning system (260) may use information regarding the hydrocarbon reservoir (104) location to plan a well, including a planned wellbore trajectory (203) from the surface (124) of the earth to penetrate the hydrocarbon reservoir (104). In addition, to the depth and geographic location of the hydrocarbon reservoir (104), the planned wellbore trajectory (203) may be constrained by surface limitations, such as suitable locations for surface position of the wellhead, Le, the location of potential or preexisting drilling rigs, drilling ships or from a natural or man-made island.

Typically, the wellbore plan is generated based on best available information at the time of planning from a geophysical model, geomechanical models encapsulating subterranean stress conditions, the trajectory of any existing wellbores (which it may be desirable to avoid), and the existence of other drilling hazards, such as shallow gas pockets, over-pressure zones, and active fault planes. Information regarding the planned wellbore trajectory (203) may be transferred to the drilling system (200) described in FIG. 2. The drilling system (200) may drill the wellbore (118) along the planned wellbore trajectory (203) to access the drilling target (230).

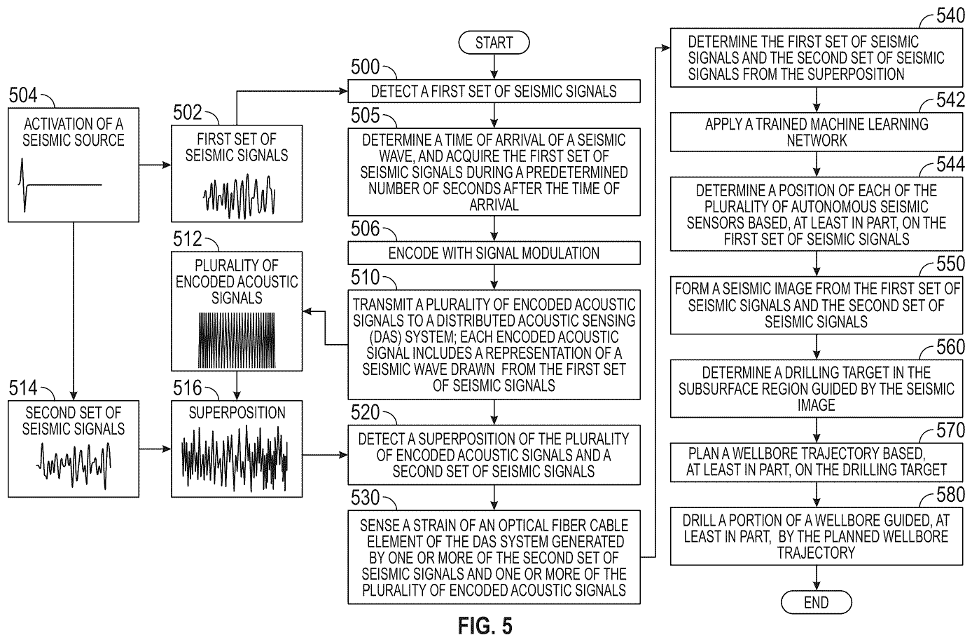

Turning to FIG. 5, FIG. 5 shows a flowchart in accordance with one or more embodiments. Specifically, FIG. 5 describes an embodiment of the inventive method to simultaneously acquire seismic data with autonomous seismic sensors and a DAS system. While the various blocks in FIG. 5 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 500, a first set of seismic signals (502) is detected by a plurality of autonomous seismic sensors (218), in accordance with one or more embodiments. A seismic source (106) may be activated, as shown in Block 504, and a first set of seismic signals (502) including radiated seismic waves (108), refracted seismic waves (424) and reflected seismic wav (114) may be detected by the autonomous seismic sensors (218). The autonomous smic sensors (218) record data with their internal sensing blocks and encode the recordings, as shown in Block 506. The first set of seismic signals (502) may be encoded onto a plurality of encoded acoustic signals (512) using any suitable signal modulation technique known in the art (e.g., frequency shift keying, phase shift keying, amplitude shift keying, etc.). In some embodiments frequency modulation is performed to shift the frequency band of the plurality of encoded acoustic signals (512) outside the frequency band of the first set of seismic signals (502).

In Block 510 the plurality of encoded acoustic signals (512) is transmitted to the DAS system, in accordance with one or more embodiments. Each encoded acoustic signal (512) comprises a representation of a seismic wave drawn from the first set of seismic signals (502). The autonomous seismic sensors (218) may transmit via the internal transmission blocks the plurality of encoded acoustic signals (512) in the form of acoustic waves (224) to the fiber-optic cables (220). In some embodiments, the autonomous seismic sensors (218) may first receive an input signal including an initial time of transmission from, for example, the drilling rig (207) or the vessel (120), before starting the transmission of the plurality of encoded acoustic signals (512).

In Block 520 a superposition (516) of the plurality of encoded acoustic signals (512) and a second set of seismic signals (514) is detected using the DAS system, in accordance with one or more embodiments. The second set of seismic signals (514) may include radiated seismic waves (108), retracted seismic waves (424) and reflected seismic waves (114) resulting from the activation of the seismic source (106) that arrive at the locations of the fiber-optic cables (220).

The plurality of encoded acoustic signals (512) transmitted in the form of acoustic waves (224) by the autonomous seismic sensors (218) deform the fiber-optic cables (220) and are thereby detected by the interrogator of the DAS system, which continuously sends the light pulses through the fiber-optic cable (220) and reconstructs the fiber deformations through analysis of the reflected light.

The data recorded by the autonomous seismic sensors (218), and its modulation and transmission through acoustic waves (224) to the fiber-optic cables (220), allow for almost real-time data transmission from the autonomous seismic sensors (218) to the surface (124) Together with the recordings, each autonomous seismic sensor (218) may transmit its unique identification number, its internal clock time, or other metadata. The following options can be realized:
a) The transmission blocks can be programmed to send the data at specific time intervals, determined based on the spatial resolution of the DAS system and the expected movement speed of the autonomous seismic sensors (218).
b) The autonomous seismic sensor (218) can be programmed to send the data based on its internal depth estimation based on hydrostatic pressure.
   The autonomous seismic sensor (218) can send all the measurements recorded during the last interval at a single time. The depths may be assigned by interpolation based on the current and previous depth identified by the DAS system.
   The autonomous seismic sensor (218) can send an average of the measurements corded within the last interval.
   The autonomous seismic sensor (218) records many measurement points but sends only the last datapoint at each interval. The rest of the recorded data are available after the autonomous seismic sensor (218) returns to the surface (124). The depths are assigned by interpolation.
c) The autonomous seismic sensor (218) can be programmed to send the data after each measurement.
d) The autonomous seismic sensor (218) detects the time of the first arrival after activation of the seismic source (106) and transmits only a predetermined number of seconds after the time of the first arrival, as shown in Block 505 of FIG. 5. The time of the first arrival may be determined with threshold-based methods, machine learning algorithms, or any other detection technique known in the art.

Sending data in batches using the methods above allows for preserving the energy in a battery-operated untethered tool.

In some embodiments, the fiber-optic cables (220) sense strains in the fiber-optic cables (220) generated by the plurality of encoded acoustic signals (512) and the second set of seismic signals (514), as shown in Block 530. The interrogator constantly sends light pulses down the fiber-optic cables (220) and the strains are registered as changes in the backscattered light transmitted back to the interrogator at the surface (124) as a function of depth and time. In this way, the first set of seismic signals (502) taken by the autonomous seismic sensors (218) are first encoded and modulated onto acoustic waves (224) until they impinge upon the fiber-optic cables (220).

In some embodiments, the superposition (516) of the plurality of encoded acoustic signals (512) and the second set of seismic signals (514) detected simultaneously by the DAS system may be sent to the surface (124) by the DAS system. Upon reaching the surface (124), the interrogator may output the superposition (516) and may pass it to the seismic processing system (240).

In Block 540 the first set of seismic signals (502) and the second set of seismic signals (514) are determined from the superposition (516), in accordance with one or more embodiments. The seismic processing system (240) may use trained machine learning networks as discussed above in FIG. 3 or other algorithms known to a person of ordinary skill in the art to separate the superposition (516) and retrieve the plurality of encoded acoustic signals (512) and the second set of seismic signals (514), as shown in Block 542. Techniques to reduce background acoustic noise may be also implemented. Further, the seismic processing system (240) may decode the plurality of encoded acoustic signals (512) to reconstruct the first set of seismic signals (502) detected by the autonomous seismic sensors (218) along with their relevant metadata. Reconstructing the first set of seismic signals (502) may include correcting for the delay in data transmission relative to the second set of seismic signals (514). The delay in data transmission is due to the time taken by the encoding and decoding procedures, as well as by the transmission of the acoustic data by the autonomous seismic sensors (218) to the fiber-optic cables (220).

In some embodiments, the position of the autonomous seismic sensors (218) may be determined by the seismic processing system (240) based, at least in part, on the first set of seismic signals (502), as shown in Block 544. In order to obtain the location of the autonomous seismic sensor (218), a positioning procedure may be performed. The autonomous seismic sensor (218) may measure the pressure and transmit it to the surface (124) with the DAS system, which allows the estimation of the autonomous seismic sensor (218) depth from the recorded pressure of the fluid column above it. A more accurate estimate of the depth of the autonomous seismic sensor (218) may be obtained from the analysis of the DAS system recordings by analysis of the acoustic energy envelope along the fiber-optic cables (220) at any given moment. A simple estimate of the depth of the autonomous seismic sensor (218) may be obtained by identifying the energy envelope maxima above a certain threshold. On the other hand, the horizontal location of the autonomous seismic sensor (218) may be computed from the arrival times of acoustic waves (224) detected by the fiber-optic cables (220). Thus, the position of the autonomous seismic sensor (218) may be determined in a three-dimensional space. The data recorded by the autonomous seismic sensors (218), its modulation and transmission through acoustic waves (224) to the fiber-optic cables (220) and to the surface (124) occur in parallel, thus enabling almost real-time data transmission from autonomous seismic sensors (218) to the surface (124) and the localization of the autonomous seismic sensors (218).

In Block 550, a seismic image (430) is formed from the first set of seismic signals (502) and the second set of seismic signals (514), in accordance with one or more embodiments. The seismic data (402) may be processed to attenuate noise and may be organized in one or more spatial dimensions (416, 418) and a time axis (414) to form a plurality of time-space waveforms (405). In some embodiments, one or more CSGs (410) may be generated with the source position corresponding to the middle of the offset, as illustrated in FIG. 4.

In some embodiments, a seismic velocity model (419) regarding the subsurface region of interest (102) may be obtained. The seismic velocity model (419) provides an estimate of at least one seismic wave propagation velocity at each location in the depth domain within the subterranean region of interest (102). Typically, a seismic velocity model (419) is specified by at least one seismic velocity for a particular wave type at a plurality of discrete grid points spanning the subsurface region of interest, but other specifications are possible. For example, the seismic velocity model (419) may be defined by a plurality of continuously varying mathematical functions.

An accurate velocity model may be useful for accurate simulations of seismic wave propagation in the subsurface. A velocity model may be constructed by processing recorded seismic data (402) obtained using a seismic acquisition system (100). Processing seismic data (402) to obtain a velocity model may be considered an inverse problem, where the applied process must determine the subsurface velocity model that resulted in the recorded seismic data (402). The various processes and techniques used to process seismic data (402) to form a velocity model may generally be categorized as either a “data-domain approach”, such as full-waveform inversion (FWD), or an “image-domain approach”, such as migration velocity analysis, Machine learning models and deep learning frameworks may be also implemented to determine a velocity model from given seismic data (402).

In some embodiments, the seismic image (430) may be determined based on the plurality of time-space waveforms (405) and the seismic velocity model (419). Various types of algorithms may be used in the generation of the seismic image (430). For example, the plurality of time-space waveforms (405) may include a source wavefield and a receiver wavefield. The source wavefield may include one or more source functions at one or more source locations (xₛ, yₛ) used during activation of the seismic source (106). The receiver wavefield may include the plurality of waveforms acquired at the seismic receivers (116).

In some embodiments, the seismic image (430) may be a migrated seismic image. The migrated seismic image may be generated with reverse time migration (RTM) using the two-way wave equation. In RTM, the source wavefield may be obtained by forward modelling the propagation of a synthetic source function using the seismic velocity model (419). A receiver wavefield may be generated using the same seismic velocity model (419) by backward propagating in time the receiver wavefield. In other words, the receiver wavefield may be first reversed in time and the used as a source function applied at the corresponding seismic receivers (116) to simulate a radiated wavefield.

The migrated seismic image may then be formed by applying an imaging condition to the receiver wavefield and the source wavefield. In some embodiments, the first imaging condition may be represented by a cross-correlation between the source wavefield with the receiver wavefield under the basic assumption that the source wavefield represents the down-going wave-field and the receiver wave-field the up-going wave-field.

In some embodiments the seismic image (430) may be obtained by merging, or stacking, different partial migrated seismic images. Each partial migrated seismic image may be generated from seismic data (402) acquired upon activation of one or more seismic sources (106).

In Block 560, a drilling target (230) in the subsurface region (102) is determined guided by the seismic image (430), in accordance with one or more embodiments. A drilling target (230) in a wellbore (118) may be determined by the seismic interpretation system (250), and may be based on, for example, an expected presence of gas or another hydrocarbon, Locations in a seismic image (430) may be delimited by geological boundaries (436, 438) and may indicate a probability of the presence of a hydrocarbon. Locations in a seismic image (430) may indicate an elevated probability of the presence of a hydrocarbon and may be targeted by well designers. On the other hand, locations in a seismic image (430) indicating a low probability of the presence of a hydrocarbon may be avoided by well designers.

In Block 570, a wellbore trajectory (203) to intersect the drilling target (230) is planned based, at least in part, on the seismic image (430), in accordance with one or more embodiments. Knowledge of the location of the drilling target (230) and the seismic image (430) may be transferred by the seismic interpretation system (250) to a wellbore planning system (260). Instructions associated with the wellbore planning system (260) may be stored, for example, in the memory (609) within the computer system (600) described in FIG. 6 below. The wellbore planning system (260) may use the knowledge of the location of the drilling target (230) and of the seismic image to plan a wellbore trajectory (203) within the subterranean region of interest (102).

In Block 580, a portion of a wellbore (118) is drilled guided, at least in part, by the planned wellbore trajectory (203), in accordance with one or more embodiments. The wellbore planning system (260) may transfer the planned wellbore trajectory (203) to the drilling system (200) described in FIG. 2. The drilling system (200) may drill a portion of the wellbore (118) along the planned wellbore trajectory (203) to access and produce the hydrocarbon reservoir (104).

In some embodiments the wellbore planning system (260), the seismic interpretation system (250), and the seismic processing system (240) may each be implemented within the context of a computer system. FIG. 6 is a block diagram of a computer system (600) used to provide computational functionalities associated with described algorithms, methods, functions, processes, flows, and procedures as described in the instant disclosure, according to an implementation. The illustrated computer (600) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (600) may include a computer that includes an input device, such as a keypad, keyboard, touch screen, or other device that can accept user information, and an output device that conveys information associated with the operation of the computer (600), including digital data, visual, or audio information (or a combination of information), or a GUL

The computer (600) can serve in a role as a client, network component, a server, a database or other persistency, or any other component (or a combination of roles) of a computer system for performing the subject matter described in the instant disclosure. The illustrated computer (600) is communicably coupled with a network (602). In some implementations, one or more components of the computer (600) may be configured to operate within environments, including cloud-computing-based, local, global, or other environment (or a combination of environments).

At a high level, the computer (600) is an electronic computing device operable to receive, transmit, process, store, or manage data and information associated with the described subject matter. According to some implementations, the computer (600) may also include or be communicably coupled with an application server, e-mail server web server, caching server, streaming data server, business intelligence (BI) server, or other server (or a combination of servers).

The computer (600) can receive requests over network (602) from a client application (for example, executing on another computer (600)) and responding to the received requests by processing the said requests in an appropriate software application. In addition, requests may also be sent to the computer (600) from internal users (for example, from a command console or by other appropriate access method), external or third-parties, other automated applications, as well as any other appropriate entities, individuals, systems, or computers.

Each of the components of the computer (600) can communicate using a system bus (603). In some implementations, any or all of the components of the computer (600), both hardware or software (or a combination of hardware and software), may interface with each other or the interface (604) (or a combination of both) over the system bus (603) using an application programming interface (API) (607) or a service layer (608) (or a combination of the API (607) and service layer (608). The API (607) may include specifications for routines, data structures, and object classes. The API (607) may be either computer-language independent or dependent and refer to a complete interface, a single function, or even a set of APIs. The service layer (608) provides software services to the computer (600) or other components (whether or not illustrated) that are communicably coupled to the computer (600). The functionality of the computer (600) may be accessible for all service consumers using this service layer (608). Software services, such as those provided by the service layer (608), provide reusable, defined business functionalities through a defined interface. For example, the interface may be software written in JAVA, C++, or other suitable language providing data in extensible markup language (XML) format or other suitable format. While illustrated as an integrated component of the computer (600), alternative implementations may illustrate the API (607) or the service layer (608) as stand-alone components in relation to other components of the computer (600) or other components (whether or not illustrated) that are communicably coupled to the computer (600). Moreover, any or all parts of the API (607) or the service layer (608) may be implemented as child or sub-modules of another software module, enterprise application, or hardware module without departing from the scope of this disclosure.

The computer (600) includes an interface (604). Although illustrated as a single interface (604) in FIG. 6, two or more interfaces (604) may be used according to particular needs, desires, or particular implementations of the computer (600). The interface (604) is used by the computer (600) for communicating with other systems in a distributed environment that are connected to the network (602). Generally, the interface (604) includes logic encoded in software or hardware for a combination of software and hardware) and operable to communicate with the network (602). More specifically, the interface (604) may include software supporting one or more communication protocols associated with communications such that the network (602) or interface's hardware is operable to communicate physical signals within and outside of the illustrated computer (600).

The computer (600) includes at least one computer processor (605). Although illustrated as a single computer processor (605) in FIG. 6, two or more processors may be used according to particular needs, desires, or particular implementations of the computer (600). Generally, the computer processor (605) executes instructions and manipulates data to perform the operations of the computer (600) and any algorithms, methods, functions, processes, flows, and procedures as described in the instant disclosure.

The computer (600) also includes a memory (609) that holds data for the computer (600) or other components (or a combination of both) that may be connected to the network (602). For example, memory (609) may be a database storing data consistent with this disclosure. Although illustrated as a single memory (609) in FIG. 6, two or more memories may be used according to particular needs, desires, or particular implementations of the computer (600) and the described functionality. While memory (609) is illustrated as an integral component of the computer (600), in alternative implementations, memory (609) may be external to the computer (600).

The application (606) is software engine providing functionality according to particular needs, desires, or particular implementations of the computer (600), particularly with respect to functionality described in this disclosure; For example, application (606) can serve as one or more components, modules, applications, etc. Further, although illustrated as a single application (606), the application (606) may be implemented as multiple applications (606) on the computer (600). In addition, although illustrated as integral to the computer (600), in alternative implementations, the application (606) may be external to the computer (600).

There may be any number of computers (600) associated with, or external to, a computer system containing computer (600), each computer (600) communicating over network (602). Further, the term “client,” “user,” and other appropriate terminology may be used interchangeably as appropriate without departing from the scope of this disclosure. Moreover, this disclosure contemplates that many users may use one computer (600), or that one user may use multiple computers (600).

In some embodiments, the computer (600) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically; cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method, comprising:
detecting, using a plurality of autonomous seismic sensors, a first set of seismic signals regarding a subsurface region of interest;
transmitting, by the plurality of autonomous seismic sensors, a plurality of encoded acoustic signals to a distributed acoustic sensing (DAS) system; wherein each encoded acoustic signal comprises a representation of a seismic wave drawn from the first set of seismic signals;
detecting, using the DAS system, superposition of the plurality of encoded acoustic signals and a second set of seismic signals regarding the subsurface region;
determining, using a seismic processing system, the first set of seismic signals and the second set of seismic signals from the superposition; and
forming, using the seismic processing system, a seismic image from first set of seismic signals and the second set of seismic signals.

2. The method of claim 1, further comprising:
determining, using a seismic interpretation system, a drilling target in the subsurface region guided by the seismic image; and
planning, using a wellbore planning system, a wellbore trajectory based, at least in part, on the drilling target.

3. The method of claim 2, further comprising drilling, using a drilling system, a portion of a wellbore guided, at least in part, by the planned wellbore trajectory.

4. The method of claim 1, wherein detecting a first set of seismic signals comprises;
determining a time of arrival of a seismic wave, and
acquiring the first set of seismic signals during a predetermined time interval after the time of arrival.

5. The method of claim 1, wherein detecting the superposition comprises sensing a strain of a fiber optic cable of the DAS system generated by one or more of the second set of seismic signals and one or more of the plurality of encoded acoustic signals.

6. The method of claim 1, wherein determining the first set of seismic signals and the second set of seismic signals comprises applying a trained machine learning network.

7. The method of claim 1, wherein a frequency band of the plurality of encoded acoustic signals is outside a frequency band of the first set of seismic signals.

8. The method of claim 1, wherein the first set of seismic signals and the second set of seismic signals comprise seismic waves generated by activation of a seismic source.

9. The method of claim 8, further comprising, determining, by the seismic processing system, a position of each of the plurality of autonomous seismic sensors based, at least in part, on the first set of seismic signals.

10. The method of claim 1, wherein transmitting the plurality of encoded acoustic signals comprises encoding with signal modulation.

11. A system comprising:
a plurality of autonomous seismic sensors configured to:
detect a first set of seismic signals, and
transmit a plurality of encoded acoustic signals, wherein each encoded acoustic signal comprises a representation of a seismic wave drawn from the first set of seismic signals;
a distributed acoustic sensing (DAS) system configured to:
detect a superposition of a second set of seismic signals and the plurality of encoded acoustic signals after transmission by the plurality of autonomous seismic sensors; and
a seismic processing system configured to:
determine the first set of seismic signals and the second set of seismic signals from the superposition, and
form a seismic image from first set of seismic signals and the second set of seismic signals.

12. The system of claim 11, further comprising:
a seismic interpretation system configured to determine a drilling target guided by the seismic image; and
a wellbore planning system configured to plan a wellbore trajectory based, at least in part, on the drilling target.

13. The system of claim 12, further comprising a drilling system configured to drill a portion of a wellbore guided, at least in part, by the planned wellbore trajectory.

14. The system of claim 11, wherein the plurality of autonomous seismic sensors is further configured to:
determine a time of arrival of a seismic wave, and
acquire the first set of seismic signals during a predetermined time interval after the time of arrival.

15. The system of claim 11, wherein the DAS system is further configured to detect the superposition by sensing a strain of a fiber-optic cable of the DAS system generated by the seismic wave and the encoded acoustic signal.

16. The system of c 11, wherein the seismic processing system is further configured to determine the first set of seismic signals and the second set of seismic signals by applying a trained machine learning network.

17. The system of claim 11, wherein a frequency band of the plurality of encoded acoustic signals is outside a frequency band of the first set of seismic signals.

18. The system of claim 11, wherein the first set of seismic signals and the second set of seismic signals comprise seismic signals generate activation of a seismic source.

19. The system of claim 11, wherein the seismic processing system is further configured to determine a position of each of the plurality of autonomous seismic sensors based, at least in part, on the first set of seismic signals.

20. The system of claim 11, wherein the plurality of autonomous seismic sensors is further configured to transmit the plurality of encoded acoustic signals by encoding with signal modulation.
